(19) United States
(12) Patent Application Publication
(10) Pub. No.: US 2026/0370361 A1
(43) Pub. Date: Nov. 19, 2026

(54) METHODS, ARCHITECTURES, APPARATUSES AND SYSTEMS FOR SENSING BASED ON MULTIPLEXED SIGNALS

(71) Applicant: InterDigital Patent Holdings, Inc., Wilmington, DE (US)

(72) Inventors: Ibrahim Hemadeh, Hemel Hempstead (GB); Yasser Mestrah, London (GB); Mohammad Heggo, London (GB); Javier Lorca Hernando, Madrid (ES); Arman Shojaeifard, London (GB); Alain Mourad, Ascot (GB); Deepa Gurmukhdas Jagyasi, London (GB); Milind Kulkarni, Hawthorn Woods, IL (US); Ghyslain Pelletier, Montreal (CA); Mohammed El-Hajjar, Southampton (GB); Pankaj Kumar, Southampton (GB)

(21) Appl. No.: 19/209,546

(22) Filed: May 15, 2025

(51) Int. Cl. H04B 17/354; H04B 1/69; H04B 17/318

(52) U.S. Cl. CPC H04B 17/354; H04B 1/69; H04B 17/318; H04B 2001/6912

(57) ABSTRACT

Methods and apparatuses are provided for sensing based on a multiplexed signal. The WTRU receives, from a wireless network, configuration information indicating a chirp sensing configuration and a condition. The WTRU receives, from the wireless network, a multiplexed signal and performs one or more measurements of the multiplexed signal based on the chirp sensing configuration. The WTRU determines a spectral leakage based on the one or more measurements and transmits, to the wireless network, a report indicating the spectral leakage based on the condition.

### TECHNICAL FIELD

The present disclosure is generally directed to the fields of communications, software and encoding, including, for example, to methods, architectures, apparatuses, systems related to chirp-orthogonal frequency division modulation (OFDM) multiplexing for opportunistic sensing.

### BACKGROUND

Devices (e.g., wireless transmit/receive units) perform sensing based on chirp signals multiplexed with communication signals for simultaneous communication and opportunistic sensing. This may introduce the challenge of mutual interference which can degrade the performance of both functionalities.

### SUMMARY

This disclosure describes a wireless transmit/receive unit (WTRU) configured for enabling multiplexed communications and sensing over the same radio resources with the purpose of performing opportunistic sensing, whilst maintaining certain communication performance. The WTRU monitors sensing and communication performance and when triggered, the WTRU measures the multiplexed signal leakage and indicates a recommended configurations to a wireless network.

In certain representative embodiments, methods and systems are provided for sensing based on a multiplexed signal. The methods and systems may include a WTRU receiving, from a wireless network, configuration information indicating a chirp sensing configuration and a condition. The methods and systems may further include receiving, from the wireless network, a multiplexed signal. The methods and systems may further include performing one or more measurements of the multiplexed signal based on the chirp sensing configuration. The methods and systems may further include determining a spectral leakage based on the one or more measurements. The methods and systems may further include transmitting, to the wireless network, a report indicating the spectral leakage based on the condition.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a transmission of signals of the same resources according to one or more embodiments;

FIG. 3 illustrates a performance comparison between OFDM-based signal with multiplexed OFDM and chirp signals according to one or more embodiments;

FIG. 4 illustrates an RS configuration and multiplexed OFDM and chirp according to one or more embodiments;

FIG. 5 illustrates chirp configurations according to one or more embodiments;

FIG. 6 illustrates an exemplary linear frequency modulation (LFM) chirp-only signal in time domain with a spectrum according to one or more embodiments;

FIG. 7 illustrates an exemplary OFDM-only signal in time domain with a spectrum according to one or more embodiments;

FIG. 8 illustrates an exemplary multiplexed OFDM and chirp LFM signal according to one or more embodiments;

FIG. 9 illustrates WTRU configurations for sensing and communication according to one or more embodiments;

FIG. 10 illustrates resource configuration for sensing according to one or more embodiments;

FIG. 11 illustrates a diagram of a multiplexed signal configuration, leakage measurement and reporting procedure according to one or more embodiments; and

FIG. 12 illustrates a method for sensing based on a multiplexed signal according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

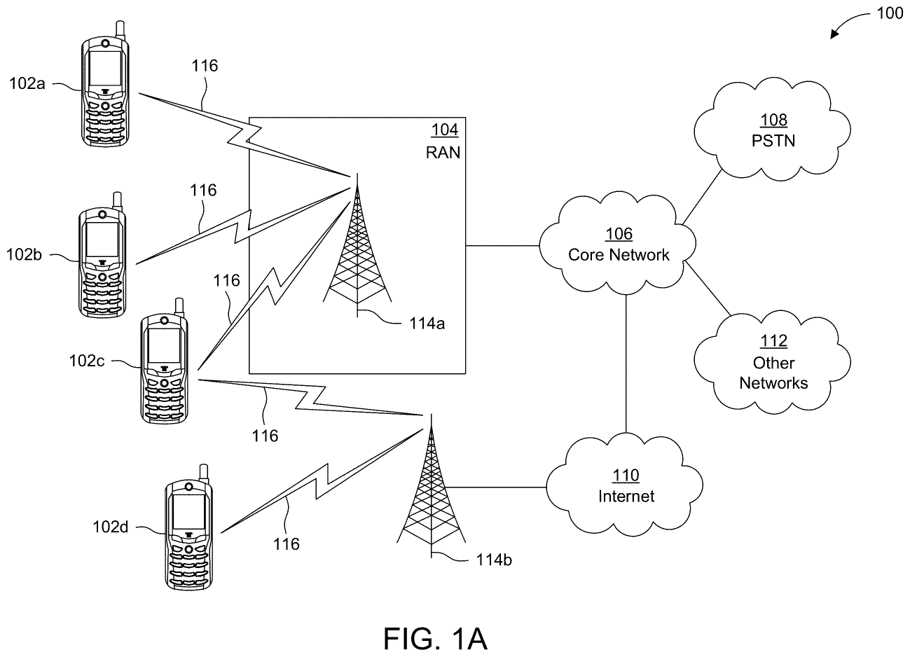

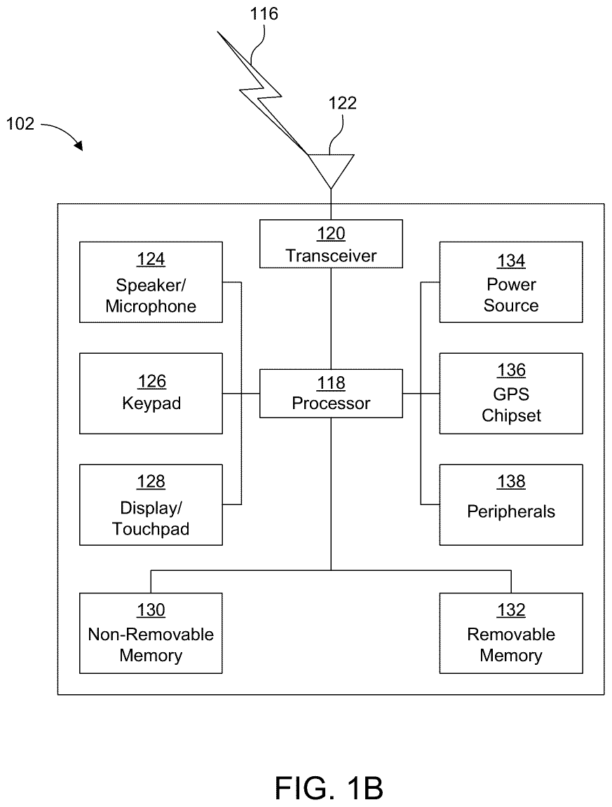

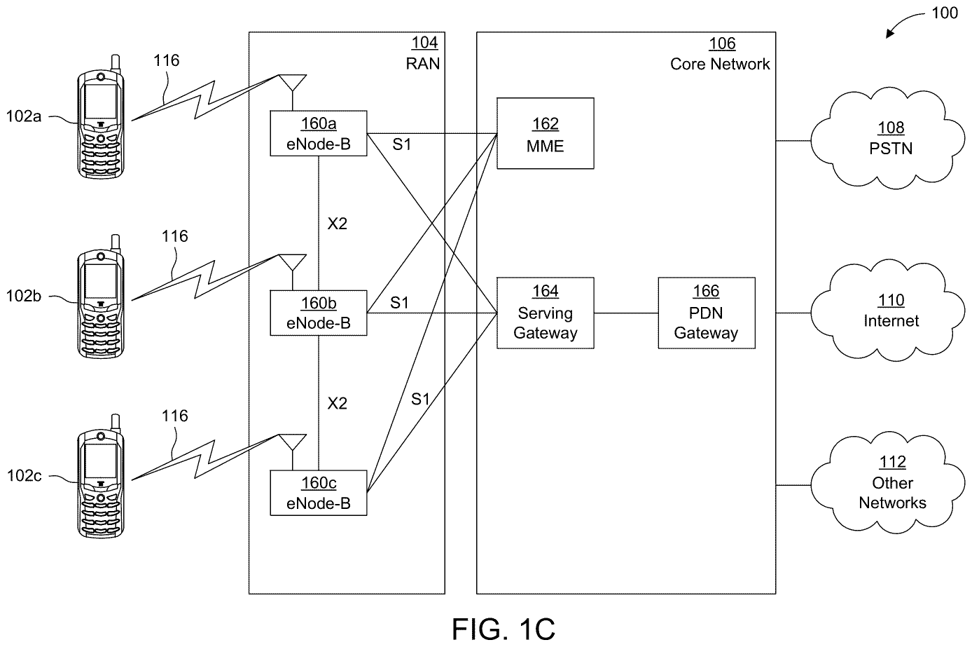

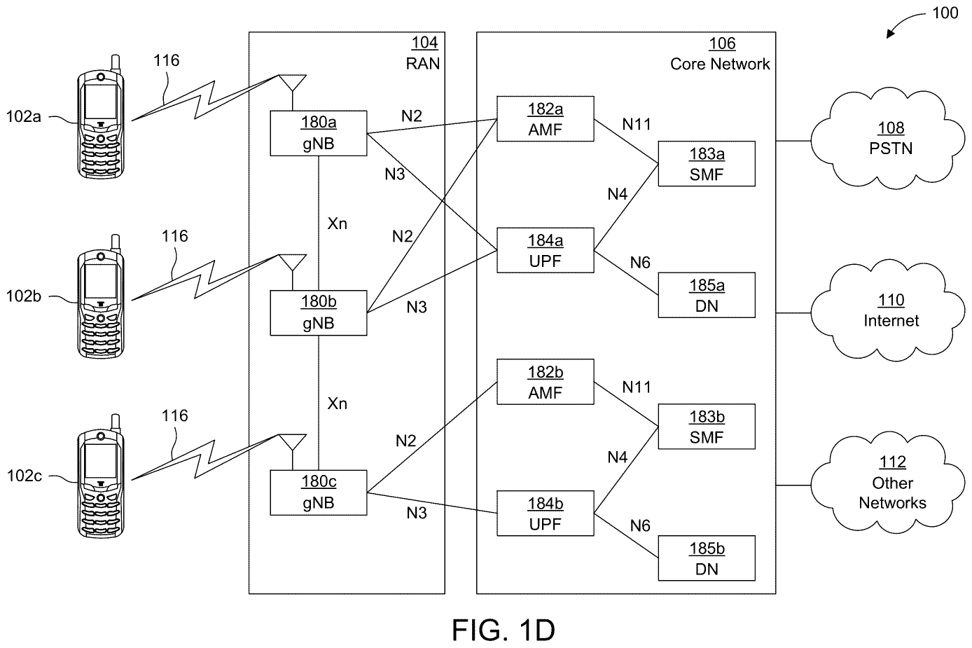

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### OVERVIEW

In certain representative embodiments, NR may employ cyclic prefix orthogonal frequency division modulation (CP-OFDM) for DL and UL, which through transform precoding may become DFT-s-OFDM for use in coverage limited scenarios in the UL. OFDM may offer high spectral efficiency and robustness against multipath fading channels with flexible time and frequency allocations, which makes it a good candidate waveform for communications.

In certain representative embodiments, in radars, chirp-based waveforms may be used. chirp-based waveforms may provide multiple advantages that enhance sensing performance, such as higher range resolution, less sensitivity to doppler shifts, and adaptability to different sensing tasks. Chirp-based waveforms provide a good trade-off between resolution, bandwidth and power, which make them ideal for radar systems.

In certain representative embodiments, the enablement of sensing in 6G is provided by leveraging existing 5G NR waveforms (CP-OFDM and DFT-S-OFDM). In certain representative embodiments, sensing complimented with chirp-like waveforms to enhance sensing performance.

In certain representative embodiments, method and systems are provided for enabling multiplexed communications and sensing over the same radio resources, e.g. multiplexed OFDM and chirp, with the purpose of performing opportunistic sensing in a multi-user setup, whilst maintaining certain communication performance. In certain representative embodiments, systems may monitor the receiver's sensing and communication performance, e.g. BLER, sensing accuracy, etc., and when triggered, e.g. sensing accuracy goes below a specific threshold, a WTRU may measure the multiplexed signal leakage, e.g. OFDM-chirp leakage, and may indicate along with recommended configurations to a network (via uplink (Uu)) or to a different WTRU (via the PC5).

In certain representative embodiments, a WTRU may receive a first configuration that includes information about a multiplexed communication and sensing signals including at least one or more of: Multiplexing measurements, e.g. OFDM-chirp leakage, chirp residual measurements, OFDM sub-carrier orthogonality, chirp relative/absolute measurements, etc.; Priority function, e.g. communication and/or sensing; Multiplexed signals leakage triggers.

In certain representative embodiments, a WTRU may determine at least one of the following measurements: Leakage measurement, e.g. OFDM-chirp leakage measurement; The chirp measurements, e.g. residual measurements post de-chirping, chirp frequencies, chirp time measurements, relative power measurements of each set of frequencies in the chirp signal.

In certain representative embodiments, a WTRU may report to the network (via Uu) or WTRU (via PC5): The leakage measurements, e.g. leakage of chirp into OFDM and/or leakage of OFDM into chirp; The chirp residual measurements; Recommended configurations, e.g. for chirp and/or OFDM; Recommended priority function.

In certain representative embodiments, OFDM and chirp signals may be multiplexed over the same time and frequency resources for multiple users to enable opportunistic sensing with communication. When both signals are transmitted over shared resources, interference would emerge resulting in a potential degradation of the performance of both sensing and communications, e.g. high interference between chirp and OFDM lead to chirp signal impairment and destruction of the orthogonality of OFDM.

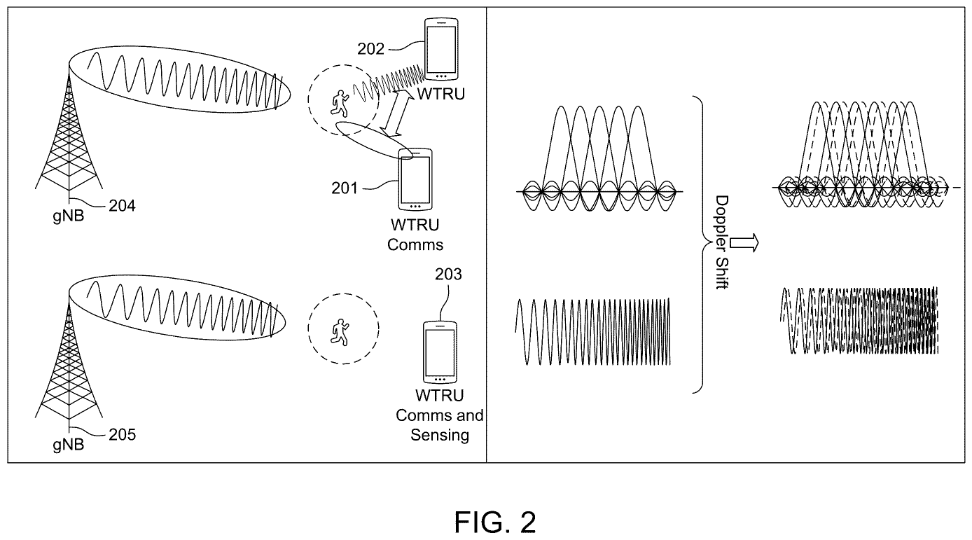

In certain representative embodiments, impairments may be introduced to the multiplexed signal by the channel, e.g. high doppler shift, etc. which may deteriorate the communication performance and/or the sensing performance. In some embodiments, when either the transmitter and/or the receiver(s) are moving (mobility scenario), the doppler shift in both the chirp and OFDM signals may lead to a frequency offset, which results in inter-carrier interference, e.g. sub-carriers interfering with each other, as well as to interference with the multiplexed chirp set of frequencies. FIG. 2 illustrates a transmission of OFDM and chirp of the same resources according to one or more embodiments. Additionally, the doppler shift resulting from the mobility of the transmitter and/or receiver may distort the chirp signal. This may result in a chirp residual in the OFDM signal post de-chirping, e.g. a portion of the chirp signal remains after removing the chirp signal with the configured chirp configuration, e.g. chirp frequencies, chirp start and end times etc. This may be referred to as the multiplexed signal leakage, e.g. OFDM-chirp leakage. In this case, the leakage may impact the performance of both the OFDM-based communication and the chirp-based sensing.

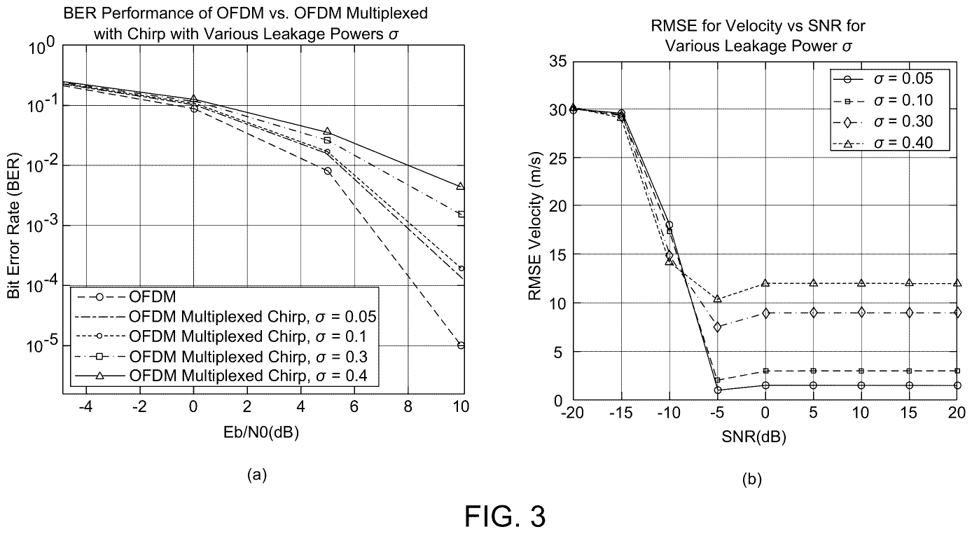

In certain representative embodiments, a performance comparison between OFDM-based signal with multiplexed OFDM and chirp signals may be performed. FIG. 3 illustrates a performance comparison between OFDM-based signal with multiplexed OFDM and chirp signals according to one or more embodiments. In FIG. 3, an OFDM is used for communication and chirp is used for sensing. Specifically, FIG. 3(a) shows the OFDM-chirp leakage level, denoted by σ, increasing and consequently degrading the Bit Error Rate (BER) performance of the communication. In contrast, as shown in FIG. 3(b), the sensing performance increases, as appreciated with the decrease of the Root Mean Squared Error (RMSE) of velocity estimation, as the OFDM-chirp leakage level increases.

In certain representative embodiments, a WTRU, is enabled to perform sensing, or both sensing and communications simultaneously, to measure and report OFDM-chirp leakage (OFDM-to-chirp and/or chirp-to-OFDM) such to minimize impact on communications services (including impact on other WTRUs).

In certain representative embodiments, a framework is provided for enabling multiplexed communications and sensing over the same resources, e.g. multiplexed OFDM and chirp, to perform opportunistic sensing whilst maintaining certain communication performance, including in the presence of multiple WTRUs. In certain representative embodiments, a WTRU1, configured to perform sensing, or sensing and communications simultaneously, monitors performance metrics, e.g. Block Error Rate (BLER), sensing accuracy, etc., and when triggered, e.g. sensing accuracy goes below a specific threshold, measures and indicates the corresponding leakage, e.g. OFDM-chirp leakage, along with recommended configurations to the network, e.g. via the Uu, or to the WTRU2, e.g. via the PC5.

In certain representative embodiments, a WTRU, such as the WTRU1 may perform at least one of the steps in the following paragraphs.

In certain representative embodiments, a WTRU may receives a first configuration that includes information about the multiplexed communication and sensing signals. The first configuration may include at least one of: Chirp configurations, e.g. chirp type, chirp rate, duration, start time, end time etc.; Multiplexing technique, e.g. NOMA, OMA, adding, multiplexing etc.; Multiplexing measurements, e.g. OFDM-chirp leakage, chirp residual measurements, OFDM sub-carrier orthogonality, chirp relative/absolute (power) measurements, etc.; Thresholds, e.g. OFDM-chirp leakage threshold, chirp residual threshold, accuracy, performance, etc.; WTRU priority function factor, e.g. for communication and/or sensing; Triggers, e.g. OFDM-chirp leakage goes above a specific threshold, Chirp residual going below/above a specific threshold, Velocity (relative/absolute) above a specific threshold, Chirp relative (power) measurements above a specific threshold, Peaks above a specific threshold, e.g. CIR peaks.

In certain representative embodiments, a WTRU may receives the multiplexed chirp-OFDM signal. In certain representative embodiments, a WTRU may performs sensing, or sensing and communications simultaneously, based on configured priority functions.

In certain representative embodiments, a WTRU may determines at least one of the following measurements: WTRU-specific measurements, e.g. WTRU velocity; Communications performance metrics, e.g. BLER, etc.; Sensing performance metrics, e.g. certainties, accuracy, RMSE, etc.; Leakage measurement, e.g. OFDM-chirp leakage measurement; Chirp-specific measurements, e.g. residual measurements post de-chirping, chirp frequencies, chirp time measurements, relative power measurements of each set of frequencies in the chirp signal, etc.

In certain representative embodiments, a WTRU may report the network via the Uu or to the WTRU2 via the PC5: Sensing related measurements with achieved accuracies; Communication related measurements with achieved performances; Leakage related measurements, e.g. leakage of chirp into OFDM and/or leakage of OFDM into chirp; Chirp residual measurements; The inter-carrier interference (ICI) measurements in the OFDM signal; Recommended configurations, e.g. for chirp and/or OFDM; Recommended priority function.

In certain representative embodiments, steps are provided from a WTRU perspective of the Uu interface, i.e., sensing and communications between the WTRU and gNB. However, the same functional principles may be applicable to sidelink (PC5) operation between a WTRU1 and a WTRU2, e.g., UE-WTRU bistatic sensing, based on appropriate signalling and interface adaptations. Data transmission may be through Uu PDSCH (Physical Downlink Shared Channel) or PSSCH (Physical Sidelink Shared Channel). Control information may be carried through PDCCH (Physical Downlink Control Channel) with DCI (Downlink Control Information), PUCCH (Physical uplink Control Channel) with UCI (Uplink Control Information) or PSSCH with SCI (Sidelink Control Information). Layer-1 feedback and HARQ processes over Uu have analogous handling in sidelink via WTRU-autonomous or gNB-configured procedures. Moreover, RRC-based configuration through Uu is similarly applicable to sidelink elements delivered through RRC configuration. Channel state information (CSI) reports for Uu are functionally aligned with link quality metrics or sensing reports over sidelink (PC5). Positioning Reference Signal (PRS) used over Uu have their counterpart in Sidelink Positioning Reference Signal (SL-PRS).

In certain representative embodiments, a WTRU may receive and decode a first network request, e.g., received through RRC signalling, to provide capability information.

In certain representative embodiments, a WTRU may receive and decode this first network request following the random-access procedure.

In certain representative embodiments, a WTRU may prepare a capability information message including information related to sensing capabilities such as maximum supported chirp rate, de-chirping methods, calibration methods, chirp measurement methods, etc.

In certain representative embodiments, the information contained in the WTRU capabilities message may include one or more of the following: Sensing processing capabilities, e.g., inverse frequency transform capabilities, maximum number of samples, etc. Sensing frequency ranges; Sensing bandwidth; Sensing modes, e.g., monostatic, bistatic, etc.; Sensing priorities; Sensing spatial resolution; Sensing time resolution; Support of Angle of Arrival (AoA) determination and related angular resolution; Sensing doppler resolution; Reflectivity sensitivity, i.e., the minimum power, Signal to Noise Ratio (SNR), absolute amplitude, etc. for the reflections to be detectable by the WTRU; Support of carrier phase measurements and related phase resolution; Support of half-duplex or full-duplex for monostatic sensing, and related parameters (e.g., frequency range, maximum allowed transmit power for sensing, etc.).

In certain representative embodiments, a WTRU may send the WTRU capability information message through RRC signalling, e.g., over PUSCH.

In certain representative embodiments, a WTRU capability information may be used by the network to optimize its configuration and resource allocation for sensing.

In certain representative embodiments, a WTRU may receive Reference Signal (RS) configuration for downlink, uplink, or sidelink, which may include one or more of the following parameters: ID (index), number of resources, resource sets, resource set ID, sequence ID, periodicity, type, repetition factor, comb pattern, comb size, spatial relation for transmission, spatial relation for reception, quasi colocation (QCL) information, subcarrier spacing, ID, number of spatial layers, start/end time for transmission, time window, power related information, beam related information, etc. Examples of DL RS are channel state information reference signal (CSI-RS), phase tracking reference signal (PTRS), positioning reference signal (PRS), sidelink (SL)-PRS, tracking reference signal (TRS), synchronization signal block (SSB), dedicated sensing RS. Examples of UL RS are sounding reference signal (SRS), SRSp, and dedicated sensing RS.

In certain representative embodiments, a WTRU may receive the chirp configuration that may include one or more of the following: chirp information, chirp multiplexing configurations, other configurations, Chirp design aspects.

Chirp information may include chirp rate, chirp duration, chirp bandwidth, chirp frequencies, chirp frequencies start and end time, chirp start and end time etc.

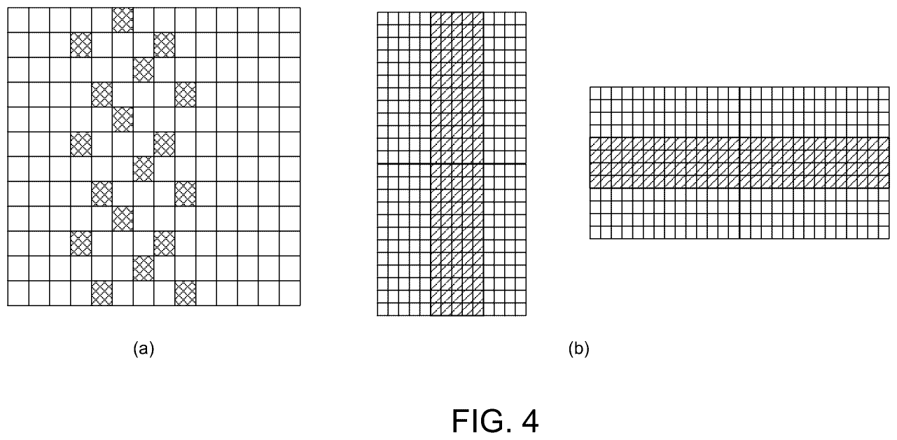

FIG. 4 illustrates an RS configuration and multiplexed OFDM and chirp according to one or more embodiments. FIG. 4(a) illustrates a dedicated RS a set of REs is used for sensing and FIG. 4(b) illustrates a multiplexed OFDM and chirp.

Chirp multiplexing configurations may include one or more of the following parameters: periodicity, repetition factor, time and frequency resources (TDD, FDD), etc.; multiplexing technique, e.g. NOMA, OMA, adding, multiplexing, etc.; multiplexing options such as Chirp-signal multiplexed with legacy reference signals as shown in FIG. 4(a), PDSCH multiplexed with chirp-based sensing signal as shown in FIG. 4(b), Chirp signal only, e.g. separate time-frequency resources for chirp; combination of the first three options, i.e. a multiplexed RS(s), multiplexed PDSCH, and/or chirp only and OFDM signals. FIG. 4 illustrates an RS configuration and multiplexed OFDM and chirp according to one or more embodiments. FIG. 4(a) illustrates a dedicated RS a set of REs is used for sensing and FIG. 4(b) illustrates a multiplexed OFDM and chirp.

Other configurations such as configurations in terms of time, frequency, power, and beamforming for chirp transmissions in the UL or SL.

Chirp design aspects such as ambiguity function, autocorrelation function, delay/doppler resolution, etc.

In certain representative embodiments, a WTRU may receive a configuration, e.g., via RRC signaling or MC-CE, that may include an indication to start a sensing task that is related to a sensing target (e.g. target localisation, tracking, etc.), or a simultaneous sensing and communication task.

In certain representative embodiments, the configuration may include chirp multiplexing measurements with its corresponding measurement time window and triggers that may include the parameters in the following paragraphs.

An indication such as a flag to activate/deactivate the chirp multiplexing measurements.

Time window for the chirp multiplexing measurement procedure, e.g., start time; minimum or/and maximum duration; number of measurement occasions for update and termination.

Triggers for initiating or terminating the chirp multiplexing measurement procedure, e.g., chirp-based triggers: e.g. WTRU initiating or terminating a chirp multiplexing measurement based on the chirp effective rate to chirp rate ratio goes above/below a specific threshold. In another example, the WTRU may initiate or terminate the chirp multiplexing measurement based on the effective chirp rate error belongs to a specific error group, e.g. the chirp rate shift error is detected in a specific group; time-based triggers, e.g., WTRU initiating or terminating a chirp multiplexing measurements at predefined intervals for periodic monitoring; event-based triggers, e.g., WTRU initiating or terminating chirp multiplexing measurements when certain signal parameters such as SINR fall below configured thresholds; location-based triggers, e.g., when WTRU enters/leaves certain geographical area, or when it detects proximity to a particular target or location. In one example, the WTRU may be triggered to initiate or terminate chirp multiplexing measurement if the measured WTRU location (e.g. using radio access technology (RAT)-dependent and/or independent methods) and the configured target location is below a certain threshold; mobility-based triggers, e.g., accounting for WTRU being stationary or mobile.

In some embodiments, the WTRU may be triggered to activate or deactivate chirp multiplexing measurements if the measured WTRU and/or target velocity is above a threshold value and/or within a range of threshold values. In another example, the WTRU may be triggered to activate or deactivate chirp multiplexing measurements if the difference between the measured WTRU and/or target velocity and the configured velocity is below a threshold value; Quality of service (QoS)-based triggers, e.g., based on sensing accuracy or resolution, positioning-based QoS (e.g., positioning resolution in meters) and reliability-based QoS (e.g., missed detection and false alarm percentages) or based on the communication performance or accuracy,

Chirp multiplexing task measurement reporting information, e.g., reporting type, e.g., periodic, semi-periodic, aperiodic; reporting measured information, e.g. absolute chirp multiplexing measurements, relative chirp multiplexing measurements with respect to the configured chirp etc.; reporting thresholds, e.g., conditions for WTRU to report chirp multiplexing measurement information based on changes in the sensing measurements or other predefined criteria; reporting content and format, e.g., raw versus processed data, statistical or instantaneous data, etc. In some embodiment, the report content may be based on the chirp multiplexing measurements (e.g. chirp rate match/mismatch, effective chirp rate). In some embodiment, the report may contain chirp based and non-chirp based sensing measurements; timing reporting granularity factor, in one example the timing reporting granularity factor may be configured based on the chirp multiplexing measurement configuration (e.g. chirp bandwidth, chirp start and end time, chirp frequencies start and end time etc.). In another example, the timing reporting granularity may be configured based on measured RS metrics such as: RSRP, RSRPP, CIR, SINR, RSRQ, etc.; reporting resources, e.g., uplink resources such as transmission power, resource blocks, and scheduling information; error handling and resensing strategies.

Reference signal information and/or DL reference signal configuration, e.g., reference signal types, for example chirp only RS, PRS, SL-PRS, etc.; resource sets; time/frequency characteristics such as pattern and density; cover codes; periodicity, time gap, and comb size; power settings; beamforming/precoding related information (e.g., beam IDs, transmission configuration indicator (TCI) settings, quasi colocation (QCL) info). Reference signal measurements: RSRPP; Reference signal received quality (RSRQ); SINR; Channel quality indicator (CQI); Rank indicator (RI); Precoding matrix indicator (PMI); Timing advance (TA); Micro-Doppler frequency.

Chirp multiplexing measurements: OFDM-chirp leakage, chirp residual measurements, OFDM sub-carrier orthogonality, chirp relative (power) measurements, etc.

Thresholds for effective chirp multiplex measurements reporting, report update and termination, e.g., static threshold to determine OFDM-chirp leakage, that may include: Thresholds for the peaks of the set of chirp frequencies, RS measurements thresholds e.g. RSRP, SINR, CIR, etc. Chirp effective rate to chirp rate ratio, the effective chirp rate error belongs to a specific error group, e.g. the chirp rate shift error is detected in a specific group, communication performance goes below a specific threshold, e.g. BER goes below a specific threshold. Measurement accuracy thresholds; update thresholds, termination thresholds, etc.

Triggers, e.g. OFDM-chirp leakage goes above a specific threshold, chirp residual going below/above a specific threshold, velocity (relative/absolute) above a specific threshold, chirp relative (power) measurements above a specific threshold, peaks above a specific threshold, e.g. CIR peaks.

Reporting configuration that may include one or more of the following: Allocated reporting uplink or sidelink control and/or data channels: Number of allocated resources, e.g. number of uplink resources, number of downlink resources, number of sidelink resources; Type of allocated resources; Type of allocation (e.g. uplink channel x is allocated to report y, uplink channel x is allocated to periodic reporting, uplink channel x is allocated to report on event y, etc.). Periodicity of reporting information: Type (periodic, aperiodic, semipersistent, etc.), Period time between two successive reports (e.g. periodic and semipersistent), Report types associated to each periodicity type (e.g. report x is periodic, while report y is semipersistent, etc.). Report content: Events detected e.g. effective chirp rate match/mismatch detection, Chirp multiplexing measurements (e.g. effective chirp rate detected), RS measurements (e.g. RSRP, RSRPP, RSCP, etc.).

In certain representative embodiments, a WTRU may receive RS configurations to perform simultaneous communication and sensing, using two signals; a communication signal, e.g. OFDM, and a sensing signal, e.g. chirp. The WTRU may receive the set of RS, which may be configured as legacy RS (e.g. PRS, CSI-RS, SSB etc.), dedicated RS signal, e.g. chirp-based RS for sensing, or with multiplexed with another signal, e.g. multiplexed OFDM and chirp signals.

In certain representative embodiments, a WTRU may receive configurations to perform simultaneous communication and sensing using a chirp signal multiplexed over a communication signal.

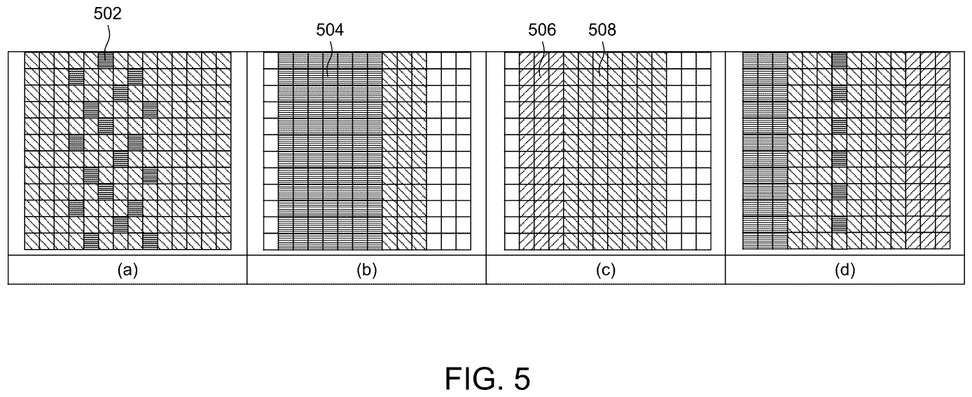

FIG. 5 illustrates chirp configurations according to one or more embodiments. FIG. 5(a) illustrates a chirp multiplexed with RS 502, FIG. 5(b) illustrates a chirp multiplexed with a portion of the PDSCH 504 and FIG. 5(c) illustrates a chirp transmitted over a separate Physical Resource Blocks (PRBs), e.g. chirp is shown in 506 and PDSCH in 508, and multiplexed resources in lined patterns. FIG. 5(d) illustrates a combination of the first three options.

In certain representative embodiments, the chirp signal may be multiplexed with a RS, e.g. PRS, CSI-RS, SSB et, as shown in FIG. 5(a).

In certain representative embodiments, the chirp signal may be multiplexed over a PDSCH signal, as shown in FIG. 5(b), where the chirp signal is multiplexed with the OFDM-based PDSCH signal over the same set of resources, e.g. frequency, time, antenna.

In certain representative embodiments, the chirp signal may be transmitted separately over a set of RE(s) or PRB(s) outside the PDSCH, as shown in FIG. 5(c).

In certain representative embodiments, the multiplexing, e.g. OFDM-chirp, may be a combination of the first three options, i.e. a multiplexed RS(s), multiplexed PDSCH, and/or chirp only and OFDM signals, as shown in FIG. 5(d).

In certain representative embodiments, the WTRU may be configured with the multiplexed communication and sensing signal, e.g. OFDM-chirp multiplexed signal, in the DL, UL or sidelink (SL). In some embodiments, the WTRU may be configured to receive the multiplexed signal in the DL, where the multiplexed signal may be received over a set of RS(s), e.g. multiplexed OFDM-chirp over CSI-RS, PRS, SSB, etc. In some embodiments, the WTRU may be configured to receive the multiplexed signal over data, e.g. PDSCH. In some embodiments, the WTRU may be configured to transmit the multiplexed signal in the UL over a set of RS(s), e.g. OFDM-chirp multiplexed SRS etc., or multiplexed in a PUSCH. In some embodiments, the WTRU may be configured to transmit the multiplexed communication and sensing signal in a SL, e.g. the WTRU may transmit an OFDM-chirp signal to another WTRU to perform communications and sensing measurements.

In certain representative embodiments, where the RS is configured with multiplexed signals, e.g. OFDM and Chirp, the WTRU may be configured to perform sensing measurements using at least one of the following: the sensing signal in the received set of RS(s), e.g. the sensing measurements are performed using the chirp signal in the received multiplexed OFDM and chirp signal; the communication signal, e.g. the sensing measurements are performed using the legacy RS(s) in the communications signal, e.g. PRS, SL-PRS, CSI-RS, DM-RS, etc.

In certain representative embodiments, where the signal, e.g. PDSCH, is configured with multiplexed signals, e.g. OFDM and Chirp, the WTRU may be configured to perform sensing measurements using at least one of the following: the sensing signal in the received set of resources of the PDSCH, e.g. the sensing measurements are performed using the chirp signal in the received multiplexed OFDM and chirp signal; the communication signal, e.g. the PDSCH.

In certain representative embodiments, a WTRU configured with priority function to perform sensing and/or communication may receive the set of reference signals with multiplexed signals, e.g. OFDM-chirp multiplexed signal. The WTRU may perform measurements on the received set of multiplexed reference signals to obtain the sensing signal measurements, e.g. chirp measurements, which include at least one of the following: the set of chirp frequencies, e.g. N_chirp frequencies, which may be measured in Hz, number of REs, number of RBs, number of symbols, etc.; the chirp bandwidth, e.g. in Hz, number of REs, number of RBs, etc.; a portion of the chirp bandwidth; the chirp rate; the chirp time duration, e.g. in terms of symbols, slots, frames, subframes, milli/microseconds, etc.; the chirp start and end time; a chirp frequency start and end time; a set of chirp frequencies start and end time; the chirp phase measurements; the chirp magnitude information, e.g. power of the chirp signal, power of subset of the chirp signal etc.

In certain representative embodiments, the WTRU may obtain additional measurements to assist with the leakage measurements. In some embodiments, the WTRU may obtain the positioning information from the network, e.g. via RRC. This positioning information may include parameters to compensate for the doppler shift measurements, which includes at least on the following: the receiver's coordinated, e.g. WTRU coordinates, e.g. absolute coordinates, relative coordinates with respect to the TRP, etc.; the receiver's mobility, e.g. WTRU mobility information, e.g. absolute velocity, relative velocity with respect to the TRP, etc.; the transmitter's coordinated, e.g. gNB/TRP coordinates, e.g. absolute coordinates, relative coordinates with respect to the WTRU, etc.; the transmitter's mobility, e.g. gNB/TRP mobility information, e.g. absolute velocity, relative velocity with respect to the WTRU, etc.

In certain representative embodiments, a WTRU may be configured with a priority function of sensing, e.g. the WTRU prioritize sensing over communication. In some embodiments, the WTRU may be configured to perform a set of measurements using the receiver RS(s), e.g. the OFDM-Chirp multiplexed RS(s), or the multiplexed sensing and PDSCH signal. The sensing measurements may be performed in a configured time window indicated to the WTRU, e.g. by the network, where the window configuration includes: the sensing start and end time, e.g. in terms of number of frame, number of slots, symbol indices, absolute time, relative etc.; the sensing duration, e.g. in terms of number of frame, number of slots, symbol indices, absolute time, relative etc.; sensing measurement periodicity; the sensing set of frequency resources within the time frame(s), e.g. set of RE(s) or PRB(s) within the PDSCH signal.

In certain representative embodiments, a WTRU may be configured, e.g. by the network, to perform at least one of the following sensing measurements: time-based measurements, e.g., Time Difference of Arrival (TDoA), Time of Arrival (ToA), Reference Signal Time Difference (RSTD), etc.; power measurements, e.g., absolute or relative Reference Signal Received Power (RSRP), Reference Signal Received Power (RSRPP), Signal-to-Noise Ratio (SNR), peak-to-sidelobe, etc.; angular measurements, e.g., Angle of Arrival (AoA), etc.; mobility/motion measurements, e.g., doppler, micro-doppler, etc.; Radar Cross Section (RCS) measurements, e.g., RCS profiles, etc.

In certain representative embodiments, a WTRU may perform measurements on the channel responses using the received set of RS(s), e.g. from one or multiple configured antenna ports. In some embodiments, the WTRU may perform at least one of the following measurements: the WTRU may obtain the channel responses, e.g. CIR, CFR, PDP etc., e.g., by performing interpolation between different resource elements over the configured frequency region, by performing inverse frequency transformations on the frequency responses, by determining the power values of the CIRs, etc.; the WTRU may obtain a set of the measured responses, e.g. CIR or PDP, which are above a configured threshold, e.g. CIR threshold, SNR threshold, RSRP thresholds etc.; the WTRU may obtain a set of responses within a configure time window, e.g. CIR or PDP; the WTRU may obtain the time/delay differences between the measured responses, e.g. CIR or PDP, within the preconfigured time window;

In certain representative embodiments, a WTRU may use the received RS(s), e.g. multiplexed OFDM and chirp RS(s), or the multiplexed PDSCH and chirp signal, to perform sensing measurements of at least one of the following: range measurements, e.g. by determining the delay measurement τ, e.g. using correlation based techniques, of the received signal to calculate the range as R≈k·c·τ, k is a real number; velocity measurements, e.g. by determining the phase difference to obtain the doppler shift f_{d} so the velocity can be obtained as v≈m·f_{d}·λ, where m is a real number; the angles, e.g. AoA; micro-doppler; RCS; sensing measurements accuracies, e.g. Root Mean Square Error (RMSE) of range/velocity estimation, accuracy of range measurement, accuracy of velocity measurement, accuracy of RCS measurement, etc.

In certain representative embodiments, the multiplexing leakage may be defined as the amount of a first signal leaking into a second signal, when both signals are transmitted simultaneously, e.g. at the same time, space and frequency resources, as results of impairments introduced by the channel, e.g. high doppler shift due to WTRU to mobility of the transmitter, receiver and/or target(s), etc.

In certain representative embodiments, the multiplexing leakage may be described as the interference, spillover, cross-talk, and spectral contamination occurring between multiple signals transmitted simultaneously over the same resources. In certain representative embodiments, this multiplexing leakage may also happen after processing the first signal of the multiplexed signal at the receiver, such as after de-chirping, which leaves residual components in the second signal.

In certain representative embodiments, the amount of leakage may refer to the amount of power of chirp signal leaking into the OFDM signal. Without loss of generality, if a first signal, e.g. OFDM, is denotes by s_{OFDM}(t), is multiplexed with a second signal, e.g., chirp signal, which is denotes as s_{chirp}(t), over the same resources, the leakage may be determined at the first signal and the second signal as provided in the following paragraphs.

The leakage of the first signal, OFDM, into the second, e.g. chirp, may be expressed as

S_{L}=σ_{L,OFDM}e^{2πΔf}^{_{OFDM}}^{t},
where Δf_{OFDM} is the frequency offset introduced by the OFDM signal leakage into the chirp signal, and σ_{L,OFDM} denote the power of the leakage of OFDM signal into the chirp signal. Without loss of generality, the multiplexing leakage of the first signal into the second signal may be expressed in the chirp signal as

s̅_{chirp}(t)=s_{chirp}(t)·(σ_{L,OFDM}e^{2πΔf}^{_{OFDM}}^{t}).

An additional frequency offset, denoted by Δf_{o,chirp}, may be introduced to chirp signal, e.g. as a result of doppler shift due to the receiver or transmitter mobility,

s̅_{chirp}(t)=s_{chirp}(t)·(σ_{L,OFDM}e^{2πΔf}^{_{OFDM}}^{t})e^{2πΔf}^{_{o,chirp}}^{t},

then,

s̅_{chirp}(t)=s_{chirp}(t)·(σ_{L,OFDM}e^{2π(Δf}^{_{o,chirp}}^{+Δf}^{_{OFDM}})^{t}),

Hence, the total frequency offset in the chirp signal amounts for the frequency offset of the chirp signal Δf_{o,chirp}, and the leakage of the OFDM signal Δf_{OFDM}.

The power of the leakage of the first signal into the second signal may be expressed as

|1−σ_{L,OFDM}|=|E[|s̅_{chirp}(t)−s_{chirp}(+)|²]|.

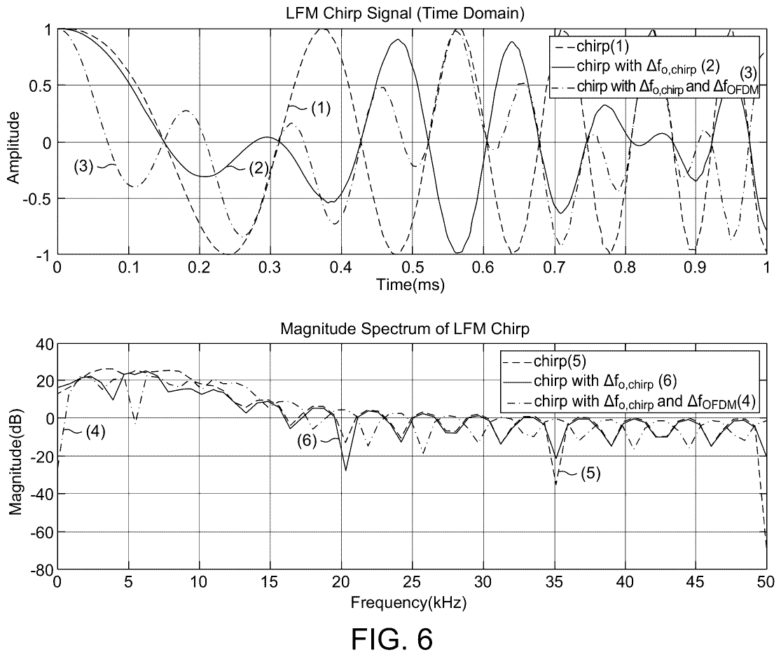

FIG. 6 illustrates an exemplary linear frequency modulation (LFM) chirp-only signal in time domain with a spectrum according to one or more embodiments. In FIG. 6, the LFM signal, the LFM with chirp frequency offset and LFM with chirp frequency offset and a second signal's leakage are shown.

The leakage of the second signal, chirp, into the first signal, e.g. OFDM, may be expressed as

C_{L}=σ_{L,chirp}e^{2πΔf}^{_{chirp}}^{t},
where Δf_{chirp} is the frequency offset introduced by the chirp signal leakage into the OFDM signal, and σ_{L,chirp} denote the power of the leakage of chirp signal into the OFDM signal. Without loss of generality, the multiplexing leakage of the second signal into the first signal may be expressed in the chirp signal as:

s̅_{OFDM}(t)=s_{OFDM}(t)·(σ_{L,chirp}e^{2πΔf}^{_{chirp}}^{t}).

An additional frequency offset, denoted by Δf_{o,OFDM}, may be introduced to OFDM signal, e.g. as a result of doppler shift due to the receiver or transmitter mobility,

s̅_{OFDM}(t)=s_{OFDM}(t)·(σ_{L,chirp}e^{2πΔf}^{_{chirp}}^{t})e^{2πΔf}_{o,OFDM}^{t},

then,

s̅_{OFDM}(t)=s_{OFDM}(t)·(σ_{L,chirp}e^{2π(Δf}^{_{o,OFDM}}^{+Δf}^{_{chirp}}^{)t}),

Hence, the total frequency offset in the OFDM signal amounts for the frequency offset of the OFDM signal Δf_{o,OFDM}, and the leakage of the chirp signal Δf_{chirp}.

The power of the leakage of the second signal into the first signal may be expressed as

|1−σ_{L,chirp}|=|E[|s̅_{OFDM}(t)−s_{OFDM}(t)|²]|.

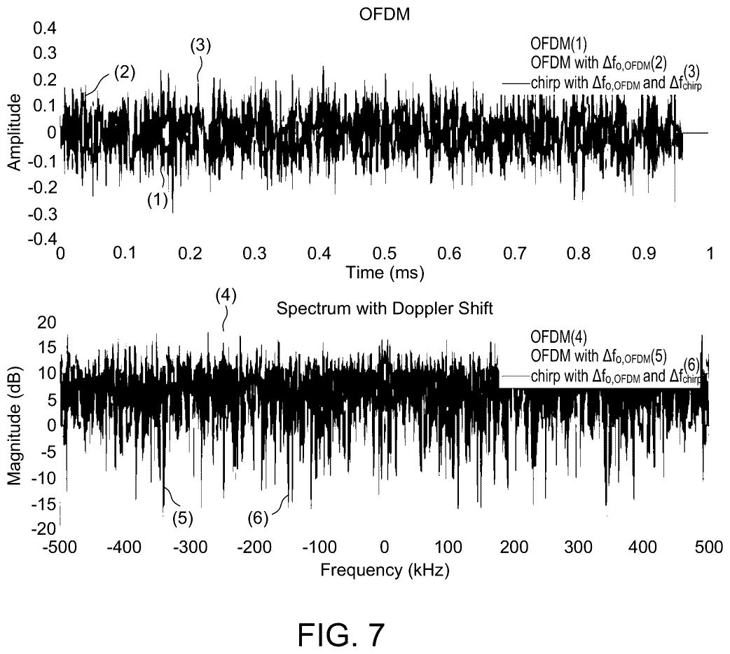

FIG. 7 illustrates an exemplary OFDM-only signal in time domain with the spectrum according to one or more embodiments. FIG. 7 shows the OFDM signal, the OFDM with OFDM frequency offset and OFDM with OFDM frequency offset and a second signal's leakage.

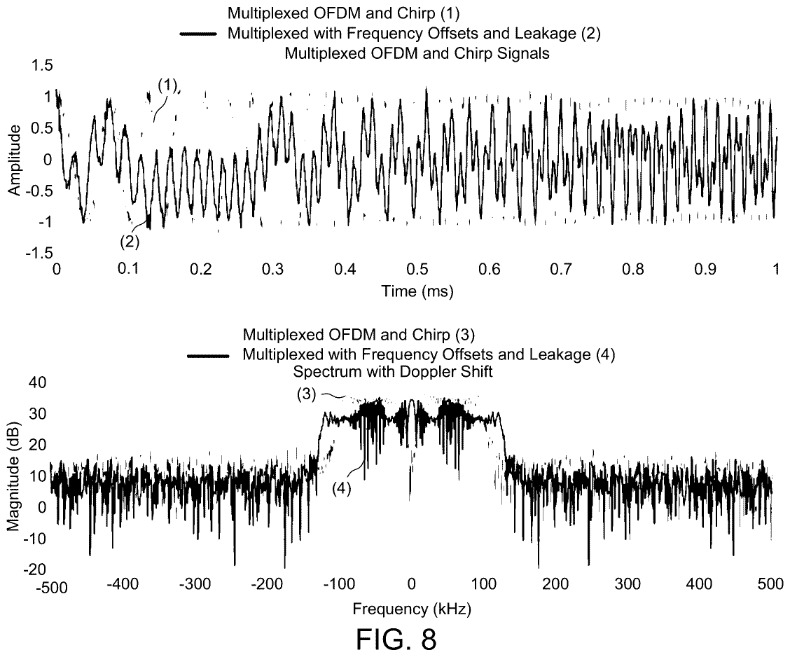

FIG. 8 illustrates an exemplary multiplexed OFDM and chirp LFM signal according to one or more embodiments. FIG. 8 illustrates the multiplexed signal in time domain and the spectrum of the multiplexed signal. In FIG. 8, the frequency offsets of both signals and leakage introduced have an impact on the time domain signal and the spectrum of the signal are shown.

In certain representative embodiments, a leakage may be referred to as the chirp residual, which is the amount of “leftover” energy of the chirp after de-chirping in the OFDM signal. In some embodiments, the chirp residual may come as a result of erroneous compensation of the frequency offsets introduced by the Tx/Rx/target(s). In some embodiments, each of the Tx/Rx/target(s) introduces a set of doppler shifts, which leads to a total frequency offset of

$${f}_{o} = {f}_{D , T x} + {f}_{D , R x} + {\sum }_{i}^{T} {f}_{D , T r ( i )} ,$$

Where f_{D,Tx} is the doppler shift of the transmitter, f_{D,Rx} is the doppler shift of the receiver, and

$${\sum }_{i}^{T} {f}_{D , T r ( i )}$$

is the total doppler shift of the T targets/motions/MC.

In some embodiments, the received OFDM and chirp multiplexed signals may be multiplexed in different ways, such as, addition and multiplication, and the Multiplication: r(t)=s_{OFDM}(t)·s_{chirp}(t), Addition: r(t)=s_{OFDM}(t)+s_{chirp}(t).

In some embodiments, given a fading channel with N taps and AWGN with a power of N₀, the received multiplexing signal may be expressed as

$$\begin{matrix}y ( t ) = {\sum }_{n}^{N} h ( t - {τ}_{n} ) \cdot r ( t ) \cdot {e}^{2 π {f}_{o} t} + n , \\ y ( t ) = {\sum }_{n}^{N} h ( t - {τ}_{n} ) \cdot r ( t ) \cdot {e}^{2 π ( {f}_{D , Tx} + {f}_{D , Rx} + {\sum }_{i}^{T} {f}_{D , Tr ( i )} ) t} + n ,\end{matrix}$$

It can be seen in y(t) that the multiplexed signal with the frequency offset, is expressed as:

$$\overline{r} ( t ) = r ( t ) \cdot {e}^{2 π ( {f}_{D , Tx} + {f}_{D , R x} + {\sum }_{i}^{T} {f}_{D , Tr ( i )} ) t}$$

And in case of using addition as the multiplexing technique, the receiver would apply de-chirping to the signal to retrieve the OFDM signal as:

$$\begin{matrix}De - chirp ( \overline{r} ( t ) ) ∼ \overline{r} ( t ) - {s}_{c h i r p} ( t ) \\ De - chirp ( \overline{r} ( t ) ) ∼ {s}_{O F D M} ( t ) + {s}_{c h i r p} ( t ) ( 1 - {e}^{2 π {f}_{o} t} ) \\ De - chirp ( \overline{r} ( t ) ) ∼ {s}_{O F D M} ( t ) + {s}_{c h i r p} ( t ) ( 1 - {e}^{2 π ( {f}_{D , Tx} + {f}_{D , Rx} + {\sum }_{i}^{T} {f}_{D , Tr ( i )} ) t} )\end{matrix}$$

The chirp residual in this this case me be expressed as the amount of the chirp leftover in the OFDM signal

$$ϵ = ( 1 - {e}^{2 π ( {f}_{D , Tx} + {f}_{D , R x} + {\sum }_{i}^{T} {f}_{D , Tr ( i )} ) t} ) \cdot$$

In some embodiments, as the error in compensating for the doppler shifts of the TX/RX/Target(s) increase, the chirp residual increases, where the chirp residual approaches zero as the UE perfectly compensate for the doppler shifts.

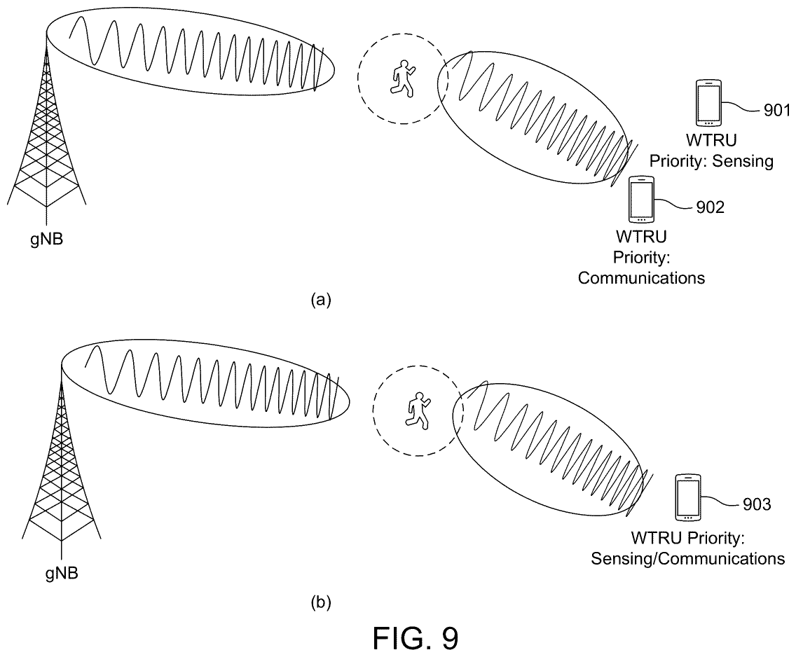

FIG. 9 illustrates WTRU configurations for sensing and communication according to one or more embodiments. In FIG. 9(a), a WTRU 901 is configured with a priority function to perform sensing and another WTRU 902 is configured with a priority function to perform communication. In FIG. 9(b), a single WTRU 903 is configured with a priority function to perform sensing and/or communication.

In certain representative embodiments, a WTRU maybe configured with a priority function to perform sensing and/or communication, which may be single WTRU in the system, as illustrated in FIG. 9(b), or be in presence of multiple users, e.g., with one WTRU configured with a priority function to perform sensing and another WTRU configured with a priority function to perform communication, as illustrated in FIG. 9(a).

In certain representative embodiments, a WTRU may determine the leakage measurement of sensing signal into communication signal, e.g. the amount of power leaking from chirp to OFDM, communication signal into sensing signal, e.g. the amount of power leaking from OFDM to chirp.

In certain representative embodiments, a WTRU may be configured with a priority function, e.g. to perform communication and/or sensing, uses the set of multiplexed RS(s), e.g. multiplexed OFDM and chirp signals, or multiplexed PDSCH and chirp signal, may perform leakage measurements.

In certain representative embodiments, when a WTRU is configured with a priority function to perform sensing, starts with performing sensing, then the WTRU may perform de-chirping of the signal, e.g. removes the chirp signal from the multiplexed signal.

In certain representative embodiments, a WTRU, e.g. configured with priority function to perform sensing, may determine the leakage of the communication signal into the sensing signal, e.g. the leakage of OFDM signal into the chirp signal, by performing one or more actions in the following paragraphs.

The WTRU may perform FFT to frequency components of the multiplexed signal post-dechirping.

The WTRU may obtain the peaks of the FFT multiplexed signal, e.g. to determine the frequency offset, e.g. Δf_{chirp}.

The WTRU may determine the chirp residual measurements post de-chirping, e.g. the amount of residual power of chirp signal in the OFDM signal after de-chirping. In one example, the de-chirping may be defined as

ε=s̅_{chirp}(t)*\ddot{s}_{chirp}(t),

ε=σ_{L,OFDM}e^{2π(Δf}^{_{o,chirp}}^{+Δf}^{_{OFDM}}^{)t},
where \ddot{s}_{chirp}(t) is the configured chirp signal, where its parameters are configured by the network.

The WTRU may determine the chirp frequency offset, e.g. Δf_{o,chirp}, using the positioning assistance information, e.g. the mobility information of the WTRU.

The WTRU determine the OFDM leakage by compensating for the chirp frequency offset, e.g. removes Δf_{o,chirp}, then ε may be expressed as

ε=σ_{L,OFDM}e^{2πΔf}^{_{OFDM}}^{t}.

The WTRU may determine the chirp residual by performing de-chirping on the chirp signal received over the separate resources, e.g. set of resources where chirp is transmitted separately

The WTRU may determine the leakage into the chirp frequencies, e.g. by determining the peaks of the set of chirp frequencies, e.g. f₁, . . . , f_{Nc}. In some embodiments, the WTRU may obtain the peaks of the frequency components of multiplexed signal, e.g. STFT, matched filter etc., and when the peaks of a specific set of frequencies is above a specific threshold then a leakage is identified at those frequencies.

The WTRU may determine the impact of the leakage on the duration of the chirp signal, e.g. by determining the relative or absolute start and end time of the chirp signal

The WTRU may determine the impact of the leakage on the duration of a specific set of frequencies the chirp signal, e.g. by determining the relative or absolute start and end time of a subset of the chirp signal, e.g. set of chirp frequencies

The WTRU may determine the communication signal frequency offset, e.g. the OFDM frequency offset, using the non-multiplexed RS(s), e.g. OFDM-based RS(s) transmitted on other set resources. In some embodiments, the WTRU may obtain the frequency offset of OFDM using the fine and coarse frequency offset, e.g. using PSS/SSS, PBCH DMRS, etc.

In certain representative embodiments, the WTRU may use a set of resources, where signal multiplexing is not applied, to determine the frequency offset of the communication signal without multiplexing. In some embodiments, the WTRU may be configured to perform communications and sensing measured on a first set of multiplexed signals, e.g. RS(s), data link etc., and perform communications and sensing using a first signal only, i.e. no sensing with a second signal.

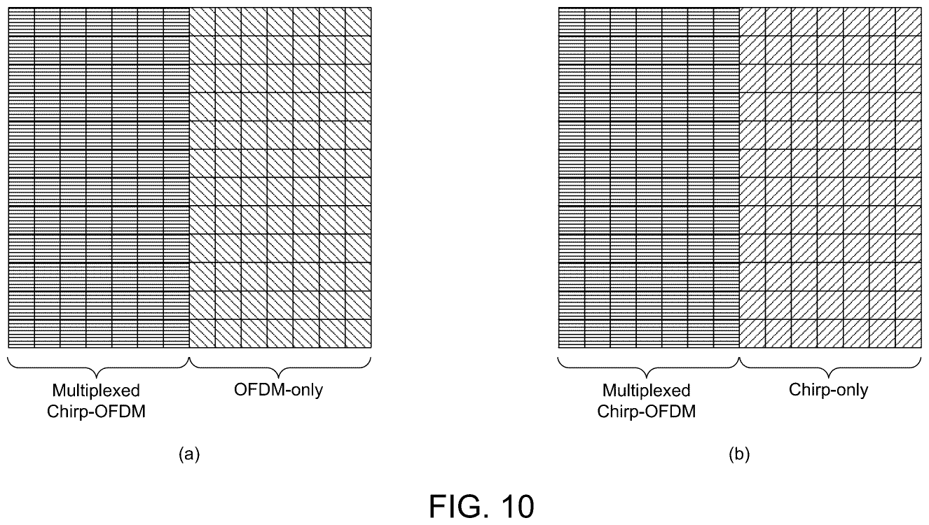

FIG. 10 illustrates resource configuration for sensing according to one or more embodiments. In FIG. 10, an example of two slots where the first seven PRBs are allocated for a multiplexed chirp and OFDM, while the remaining seven PRBs are allocated for OFDM-based PDSCH only in the first slot, and the remaining seven PRBs are allocated for chirp-only signals in the first slot is provided.

In some embodiments, the WTRU may receive the multiplexed signal over a set of resources allocated for multiplexed PDSCH, e.g. chirp multiplexed PDSCH, and another non-multiplexed signal resources, as illustrated in FIG. 10. In some embodiments, the WTRU may obtain the OFDM frequency offset on the non-multiplexed resources, e.g. non-multiplexed RS(s), non-multiplexed PDSCH etc. The frequency offset of OFDM over non-multiplexed resources may be obtained using the fine and coarse frequency offset measurement technique, e.g. using PSS/SSS, PBCH DMRS, etc. In some embodiments, if a known OFDM-based x[n], e.g. PSS, SSS, DMRS, etc is transmitted, the UE may determine the frequency offset by applying the conjugate of x[n] to the received signal y[n] as

Δf_{OFDM}=kᵢ<Σ(y[n]·x*[n]),

Where kᵢ is a constant depending on the time duration of the OFDM-based signal.

In certain representative embodiments, a WTRU may use the frequency offset measurements obtained from a non-multiplexed set of resources as a parameter for obtaining the frequency offset measurements in the multiplexed resources.

In certain representative embodiments, the WTRU may use the received non-multiplexed signals, e.g. chirp-only resources, such as time slots or PRBs with chirp-only signals, as illustrated in FIG. 10, to determine chirp-only measurements. These measurements may include doppler shifts and frequency offsets specific to chirp-only signals, detailed chirp measurements like chirp rate, chirp frequencies, chirp duration, chirp start and end times, and sets of chirp frequencies' start and end times and durations etc. Additionally, the WTRU may obtain and analyse the peaks obtained from performing FFT both before and after de-chirping.

In certain representative embodiments, when a WTRU is configured with a priority function to perform sensing, starts with performing sensing, as detailed above, then performs de-chirping of the signal, e.g. removes the chirp signal from the multiplexed signal.

In certain representative embodiments, the WTRU, e.g. configured with priority function to perform communication, may determine the leakage of the sensing signal into the communication signal, e.g. the leakage of chirp signal into the OFDM signal, as follows:

The WTRU may determine the OFDM frequency offset, e.g. Δf_{o,OFDM}, using the positioning assistance information, e.g. the mobility information of the WTRU.

The WTRU determine the chirp leakage by compensating for the OFDM frequency offset, e.g. removes Δf_{o,OFDM}, then e may be expressed as

ε=σ_{L,chirp}e^{2πΔf}^{_{chirp}}^{t}.

The WTRU may determine the chirp signal frequency offset, e.g. the chirp frequency offset, using the non-multiplexed RS(s), e.g. chirp-only signal transmitted on other set resources. In one example, the WTRU may obtain the frequency offset of chirp by de-chirping the chirp signal transmitted over chirp-only signal. In this example, the WTRU perform FFT on the de-chirped signal and obtain the peaks to obtain the chirp frequency offset as

$$Δ {f}_{c h i r p} = \frac{{f}_{p e a k}}{{T}_{c h i r p}} \cdot$$

In certain representative embodiments, the WTRU may determine the average chirp frequency offset by getting the average of N peaks received over the chirp duration as

$$Δ {\overline{f}}_{c h i r p} = \sum \frac{{f}_{p e a k}}{N {T}_{c h i r p}} \cdot$$

The WTRU may use the obtained chirp frequency offset of average chirp frequency offset to obtain the leakage of chirp to OFDM in the multiplexed OFDM-chirp signal.

The WTRU may perform de-chirping of the multiplexed signal, then obtain the set of OFDM frequencies, e.g. using FFT, STFT etc. In certain representative embodiments, the WTRU may obtain the absolute or relative of the OFDM frequencies. The WTRU may use these measurements to obtain the relative/absolute frequencies powers above a specific threshold to determine a set of frequencies in OFDM where the leakage occurred.

In certain representative embodiments, the WTRU may obtain the Inter-Cell Interference. (ICI) measurements

In certain representative embodiments, the WTRU may obtain the communication reliability measurements, e.g. Block Error Rate (BLER) etc.

In certain representative embodiments, conditions for starting, updating, or terminating the leakage measurements may comprise one or more of conditions provided in the following paragraphs.

Triggering conditions for leakage measurement, as one or more of: one or more of the velocity of the WTRU or sensed targets exceeding a given threshold, or a set of given thresholds, or being inside or outside a given range, over the configured measurement window; uncertainty in one or more of the sensing metrics (e.g., ToA, AoA, SNR, RSRPP, RSCP, etc.) of any of the WTRU or sensed targets above a threshold or set of thresholds per each sensing metric; an MSE of any of the position or velocity of the WTRU or sensed targets above a threshold; an SNR or RSRPP below a threshold for the one or more LOS/MPC components corresponding to any of the WTRU or sensed targets; a decrease in the SNR or RSRPP above a threshold for the one or more LOS/MPC components corresponding to any of the WTRU or sensed targets; a communication error metric (e.g., bit or block error rate, ACK/NACK, retransmission attempts) above a threshold; a difference between the configured and measured values of any of the chirp rate, chirp frequencies, chirp start and end time, chirp duration, or chirp bandwidth above a threshold; a power of the chirp signal above a threshold; absolute power of a frequency bin, e.g. pre-dechirping and/or post-dechirping goes above a specific threshold; relative power of a frequency bin, e.g. pre-dechirping and/or post-dechirping goes above a specific threshold; chirp residual value post-dechirping goes above a specific threshold; an explicit indication to measure leakage for one or more multipath components over a configured or pre-determined time window, each specified by any of: MPC number in the estimated CIR. Absolute or relative ToA (e.g., with respect to another multipath component); AoA (e.g., specified with respect to a known orientation, or given by the rotation angles, Euler angles, etc.); RCS (e.g., in dB or natural units according to a pre-defined format); threshold RSRPP or SNR.

Triggering conditions for updating the leakage measurements by the WTRU, as one or more of: a change in one or more of the velocity of the WTRU or sensed targets exceeds a threshold, or set of thresholds, or is inside or outside a range, over the configured measurement window; a change in the uncertainty in any of the sensing metrics above a threshold; a change in the MSE of the position or velocity of any of the WTRU or sensed target, or set of sensed targets, above a threshold; a change in any of the SNR, RSRPP, or LOS/NLOS likelihood for the one or more LOS/MPC components corresponding to any of the WTRU or sensed targets above a threshold; a change in a communication error metric (e.g., bit or block error rate) above a threshold; a time elapsed since the last leakage measurements exceeding an absolute or relative duration, e.g., a configured periodicity; a WTRU re-configuration message containing updated configuration parameters for leakage measurements; a change in the detected chirp resources, e.g., the birth or death of one or more chirps at their configured time-frequency locations, or the corresponding antenna ports; a change in any of the chirp rate, chirp frequencies, chirp start and end time, chirp duration, or chirp bandwidth above a threshold, or set of thresholds; a change in the power of the chirp signal above a threshold; a network request.

Triggering conditions for termination of leakage measurements, as one or more of: one or more of the velocity of the WTRU or sensed targets is below a threshold, or set of thresholds, or is inside or outside a range, over the configured measurement window; uncertainty in one or more of the sensing metrics (e.g., ToA, AoA, SNR, RSRPP, RSCP, etc.) of any of the WTRU or sensed targets below a threshold or set of thresholds per each sensing metric; a MSE of any of the position or velocity of any of the WTRU or sensed targets below a threshold; chirp residual value post-dechirping goes above a specific threshold; an SNR or RSRPP above a threshold for the one or more LOS/MPC components corresponding to any of the WTRU or sensed targets; a communication error metric (e.g., bit or block error rate) below a threshold; a difference between the configured and measured values of any of the chirp rate, chirp frequencies, chirp start and end time, chirp duration, or chirp bandwidth below a threshold; a power of the chirp signal below a threshold; a network request containing an indication from the network to fallback to sensing resources (e.g., not based on chirps), e.g., determined by the configuration, or explicitly indicated by their BW, no. symbols, periodicity, Transmission Configuration Indication (TCI) states, antenna ports, etc.; a time elapsed since the last leakage measurements exceeding a maximum absolute or relative duration; A low-battery indication by the WTRU.

In certain representative embodiments, after receiving a network request for termination of leakage measurements, the resources of a sensing RS to fallback by the WTRU are determined by the configuration of the localization or sensing RS resources. In certain representative embodiments, the resources may be explicitly indicated as part of the network request, containing, e.g., the Bandwidth (BW), no. symbols, periodicity, TCI states, antenna ports, etc.

In certain representative embodiments, a WTRU may perform chirp-OFDM multiplexing measurements (e.g., OFDM-chirp leakage, chirp residual measurements) and reports/sends/recommend to NW (e.g., gNB and/or LMF and/or sensing entity), or SL, in periodic, aperiodic or semi-persistent from over an uplink control or data channel.

In certain representative embodiments, a WTRU may determine the report mode based on one or more of the following: reporting configuration; triggered event; measurements; NW entity that initiated the procedure; priority function between sensing and communications; Other defined parameters.

In certain representative embodiments, a WTRU may trigger to report/indicate/include in the chirp-OFDM multiplexing report measurement related information that may include one or more of the following: sensing measurements associated with target object with uncertainties; communication measurements with uncertainties; measurement method used (absolute and/or relative); measurement search window (e.g. length of the window, type, method used to calculate, start time of the window, etc.); the set of WTRU actions performed; measurement triggers; measurements granularity; measurement reference values.

In certain representative embodiments, a WTRU may determine the event of chirp-OFDM multiplexing based on measurement type. The WTRU sends the report to the NW that may contain one or more of the following: the leakage measurements event, e.g. OFDM-chirp leakage The chirp residual measurements event; the ICI measurements event in the OFDM signal.

In certain representative embodiments, a WTRU may report/suggests/recommend to the NW as a function of the determined triggering event one or more of the following: reconfiguration for sensing; reconfiguration for communication; power ratio distribution, e.g., x power for sensing and y power for communication; indicate termination of the chirp-OFDM multiplexing procedure; perform separate tasks following preconfigured priority function (perform either sensing or communication); stop reporting of sensing and/or communication reports; change in report periodicity.

In certain representative embodiments, a WTRU may send the related measurements and report to the relevant entity based on reference signal configuration.

In certain representative embodiments, a WTRU may send sensing measurements in addition to other measurements to sensing entity (e.g., sensing entity, gNB, LMF) mainly responsible for sensing.

In certain representative embodiments, a WTRU may send communication measurements in addition to other measurements to the relevant communication entity (e.g., gNB, NW) mainly responsible for communication.

In certain representative embodiments, a WTRU may send all measurements (e.g., sensing, communication, OFDM-chirp multiplexing measurements, etc.) to the sensing entity and/or communication entity.

In certain representative embodiments, a WTRU may send the report to the entity that initiated the procedure.

In certain representative embodiments, a WTRU may indicate through reporting an index the leakage measurement level, whereby the index corresponds to one or plurality of pre-configured leakage measurement level.

In certain representative embodiments, a WTRU may indicate through one-bit signalling the event that the leakage measurement level falling above/below configured threshold.

In certain representative embodiments, a WTRU may send the chirp-OFDM multiplexing measurement report over any configured uplink control or data channel. In certain representative embodiments, the WTRU may be configured to send each report mode on preconfigured uplink control or data channel based on the report type and/or triggering event type (e.g. report mode 1 sent over PUSCH, while report mode 2 over PUCCH).

In certain representative embodiments, the measurement report may be transmitted through PUSCH e.g. via RRC/MAC-CE through a configured scheduling mechanism (configured grant or bits in the UCI field). In another solution, the WTRU may implicitly indicate the leakage measurement trigger implicitly by selection of certain UL resources (e.g., PUSCH, PUCCH, SRS, SRSp, etc.).

In certain representative embodiments, a WTRU may be configured to send decoding information (e.g. report format, type of content, allocated fields for each measurement, etc.) for the chirp-OFDM multiplexing measurement report on specific uplink control or data channel (e.g. the WTRU may send the decoding information of the report associated with sensing and communication multiplexing on the PUCCH). In another example, the gNB may blind-decode the received measurement chirp-OFDM multiplexing report from the WTRU. In certain representative embodiments, the WTRU may be configured to send its report to the network on a specific uplink control or data channel based on the measurement time granularity.

In certain representative embodiments, a WTRU may be configured to send its report to the network on a specific uplink control or data channel based on the report periodicity type (e.g. periodic, aperiodic, semi-persistent, etc.).

In certain representative embodiments, a WTRU may determine the event of chirp-OFDM multiplexing procedure and report to the network in a periodic, aperiodic or semi-persistent form. n certain representative embodiments, the WTRU may be configured with specific reporting periodicity that is associated to the determined event (e.g., OFDM-chirp leakage event, chirp residual event, ICI event, etc.). In certain representative embodiments, the WTRU may be configured with reporting periodicity that is associated to the likelihood of OFDM-chirp leakage. n certain representative embodiments, the WTRU may be configured with a specific reporting periodicity that is associated to the reliability of sensing and/or communication measurements.

In certain representative embodiments, a WTRU may perform measurements on the RS reflected from the target over multiple measurement occasions (multi-slot level, e.g., repetition factor, time gap configurations). The WTRU may determine that the chirp-OFDM multiplexing measurement report may be invalid or outdated based on one or more of the following: the change of the OFDM-chirp leakage above or below a preconfigured threshold; the change of the chirp residual measurements above or below a preconfigured threshold; the change of the ICI measurements above or below a preconfigured threshold; the change of WTRU location, e.g., moving outside a preconfigured geographical location, that may be changing in positioning measurements either from serving TRP or neighbor TRPs reflected change of one or more positioning related measurements above or below a predefined threshold; the change of target location, e.g., target location outside a preconfigured sensing area, that may be changing in target sensing measurements reflected change of one or more positioning related measurements above or below a predefined threshold; the change of environment, e.g., captured by change in CIR, PDP, DP, etc.; the change of triggering event conditions; the change in the measured RS metric(s) and/or KPI(s) over a preconfigured threshold; receiving update request by other NW entity, e.g., gNB, LMF, SF.

Based on any of the above, the WTRU may perform chirp-OFDM multiplexing measurements, the WTRU may determine to send an updated chirp-OFDM multiplexing measurement report in aperiodic, periodic or semi-persistent form over an UL control or data channel, containing one or more of the following: time stamp of the updated measurements, e.g., in absolute or relative time, or number of slots, frames, etc. relative to a known reference; updated antenna ports involved in the measurements; updated reference signal resources employed in the measurements; updated sensing measurements and uncertainties; updated communication measurements and uncertainties; updated OFDM-chirp leakage values; updated chirp residual values; updated validity window.

In certain representative embodiments, a WTRU may be configured to report the invalidity of its sensing and/or communication measurement report to the network.

In certain representative embodiments, a WTRU may be configured to perform the measurements over multiple measurement occasions (multi-slot level, e.g., repetition factor, time gap configurations). The WTRU may determine that reporting the chirp-OFDM multiplexing measurements can be terminated based on one or more of the following: the determination of no change of OFDM-chirp leakage measurements over a predefined period; the determination of no change of Chirp-OFDM leakage measurements over a predefined period; the determination of no change of chirp residual measurements over a predefined period; the determination of no leakage measurements over a predefined period; the determination of no change in one or more of triggered WTRU behaviors over a predefined period; achieving the sensing requirements over a predefined period; a time elapsed since the last reporting of precoding feedback information exceeding a maximum absolute or relative duration; a low-battery indication by the WTRU; a termination indication by the network.

In certain representative embodiments, based on any of the above, a WTRU may terminate the chirp-OFDM multiplexing procedure and may send a report over an UL control or data channel containing the recommendation to terminate the measurement procedure and one or more of the following: termination indicator. In some embodiments, the termination indicator may refer to the reason of termination. In some embodiments, termination indicator=1 refers to determination of no change of leakage for N measurement occasions. While an indicator value=2 refers to determination of no change of chirp residual for N measurement occasions; termination time stamp; detailed termination reason including one or more of the aforementioned reasons; the latest OFDM-chirp measurements report including, requested information, existing triggering conditions, WTRU actions performed, time stamps, RS signal ID used for sensing, etc.

In certain representative embodiments, a WTRU may be configured with a priority function to perform sensing and/or communication using a chirp-OFDM multiplexed signal.

The WTRU may be configured to receive the multiplexed signals based on at least one or more of the following: the WTRU may receive a set of multiplexed RS(s); the WTRU may receive a communication signal, e.g. PDSCH, that is multiplexed with chirp; the WTRU may receive a set of OFDM-chirp signals, which are orthogonally multiplexed.

In certain representative embodiments, the WTRU may perform at least one of the following: the WTRU may receive the set of multiplexed RS(s), e.g. chirp multiplexed PRS/CSI-RS etc.; the WTRU may receive the set of multiplexed signals, e.g. chirp multiplexed with PDSCH etc.; the WTRU may use the received multiplexed signals to perform chirp measurements, e.g. including chirp time measurements, chirp rate; the WTRU may use the received multiplexed signal(s) to perform sensing measurements, e.g., range/velocity estimation, sensing certainties, sensing accuracies, etc.; the WTRU may use the received signals to perform the set of OFDM to chirp leakage measurements, e.g. defined above.

In some embodiments, the WTRU may determine: the total doppler of the received signal, e.g. including the doppler shift of the Tx, Rx and target(s); the frequency offset(s) introduced to the chirp multiplexed signal.

In some embodiments, the WTRU may perform the de-chirping of the multiplexed signal, e.g. to remove the chirp signal.

In some embodiments, the WTRU may use the de-chirped signals to obtain the multiplexed signal leakage measurements, e.g. defined in above. In some embodiments, the WTRU may determine: the peaks of FFT post de-chirping; the frequency offset after de-chirping; the chirp residual measurement; the relative/absolute frequency powers.

In some embodiments, the WTRU may use the received signals over non-multiplexed chirp-only resources, time slots/PRBs with chirp only signal, to determine the following measurements: the doppler shifts for chirp-only; the frequency offsets for chirp-only; the chirp measurements, e.g. chirp rate, chirp frequencies, chirp duration, chirp start and end time, a set of the chirp frequencies start and end time, a set of the chirp frequencies durations, etc.; the peaks obtained after performing FFT (before de-chirping); the relative/absolute frequency powers; the peaks obtained after performing FFT (after de-chirping); the relative/absolute frequency powers.

In some embodiments, the WTRU may use the received signals over non-multiplexed OFDM-only resources, e.g. PDSCH etc., to determine the following measurements: the doppler shifts for OFDM-only, the frequency offsets for OFDM-only, sub-carrier orthogonality measurements, e.g. ICI measurements.

In certain representative embodiments, the WTRU may use the obtained leakage measurements, e.g. frequency offsets introduced by different each signal to the other, as well as the assistance information, e.g. positioning measurements, Tx/Rx/targets velocity measurements, in order to calibrate the received signal. In this example, the WTRU may perform at least one of the following: use the doppler measurements in order to de-chirp the multiplexed signal with the aid; to evaluate the reliability of the estimated chirp signal, sensing measurements according to the sensing task, residual measurements etc.

In certain representative embodiments, if the priority function is set for the WTRU to perform sensing only, then, the WTRU may perform sensing measurements, the WTRU may perform chirp measurements; the WTRU may determine the leakage measurements in the chirp signal only, e.g. frequency offsets, leakage of OFDM into chirp, etc.; the WTRU may optionally perform de-chirping and obtain the chirp residual measurements, the FFT peaks post de-chirping, the relative/absolute frequency powers; the WTRU may optionally perform the communication measurements and extract the communication data.

In certain representative embodiments, if the priority function is set for the WTRU to perform communication only, then, the WTRU may performs chirp measurements, the WTRU may determine the leakage measurements in the chirp signal only, e.g. frequency offsets, leakage of OFDM into chirp, etc., the WTRU may perform de-chirping to the multiplexed signal, the WTRU may obtain the chirp residual measurement, the WTRU may obtain the FFT peaks (post de-chirping), the WTRU may perform the communication measurements, e.g., BER/BLER, SNR, etc.

In certain representative embodiments, if the priority function is set for the WTRU to perform simultaneously both sensing and communication, then the WTRU may perform all above-mentioned steps for performing sensing and communication measurements, the de-chirping for sensing, and the decoding for communication. In certain representative embodiments, a WTRU may perform sensing measurements, the WTRU may perform chirp measurements, the WTRU may determine the leakage measurements in the chirp signal only, e.g. frequency offsets, leakage of OFDM into chirp, etc. The WTRU may perform de-chirping to the multiplexed signal. The WTRU may perform the communication measurements, e.g., BER/BLER, SNR, etc.

In certain representative embodiments, a WTRU may determine the RS/configured information is insufficient/unreliable/outdated e.g. when one or more of the following is determined: a WTRU may measure interleaved measurements such as multiplexing leakage (e.g., leakage of chirp into OFDM, and/or leakage of OFDM into chirp etc.,) and when multiplexing leakage level goes above a threshold, the WTRU may prioritized to perform a sensing task and sensing accuracy is below a specified threshold. The WTRU may be prioritized to perform a sensing task and communication accuracy is above a specified threshold. The WTRU may be prioritized to perform a communication task and communication accuracy is below a specified threshold. The WTRU may be prioritized to perform a communication task and sensing accuracy is above a specified threshold. The measured SNR or RSRPP is below a threshold for the one or more LOS/MPC components corresponding to any of the WTRU or sensed targets. The residual measurements post de-chirping is above a specified threshold.

In certain representative embodiments, any of the performed measurements i.e., sensing-specific or communication-specific or both do not satisfy configured thresholds and the WTRU may perform one or more actions as below: when the multiplexing leakage level goes above a threshold, the WTRU may request an updated configuration (e.g., updates chirp rate, more allocated resources, etc.), the WTRU may indicate that sensing can no longer be performed (terminate sensing), the WTRU may indicate that communication can no longer be performed (terminate communication), the WTRU may send the recommendation for updated configuration (e.g., for chirp or OFDM or both), the WTRU may send the recommendation for the priority function based on the performed measurements i.e., sensing or communication.

In certain representative embodiments, when the multiplexing leakage level goes above a given threshold, the WTRU may attempt to compensate for the leakage before proceeding to the de-chirping for sensing and/or decoding for communication. The compensation for the leakage may be inherent to the WTRU or may also be part of the configuration outlined in above paragraphs).

In certain representative embodiments, if the uncertainty level of the measurement of the multiplexing leakage goes above a given threshold, the WTRU may then request to the network some assistance to measure the leakage more accurately, such as by switching off the multiplexing of OFDM and Chirp in a given set of resources and for a given measurement time window.

In certain representative embodiments, when a triggering event occurs, the WTRU may report to the network, as detailed above, at least one of the following: sensing measurements, communication measurements, leakage measurements, e.g. leakage of OFDM to chirp and leakage of chirp to OFDM, frequency offsets for chirp, frequency offsets for OFDM, relative/absolute powers, peak of FFT of the multiplexed signals, measurements of chirp-only signal, measurements of OFDM-only signal, chirp residual, chirp measurements, the ICI measurements event in the OFDM signal.

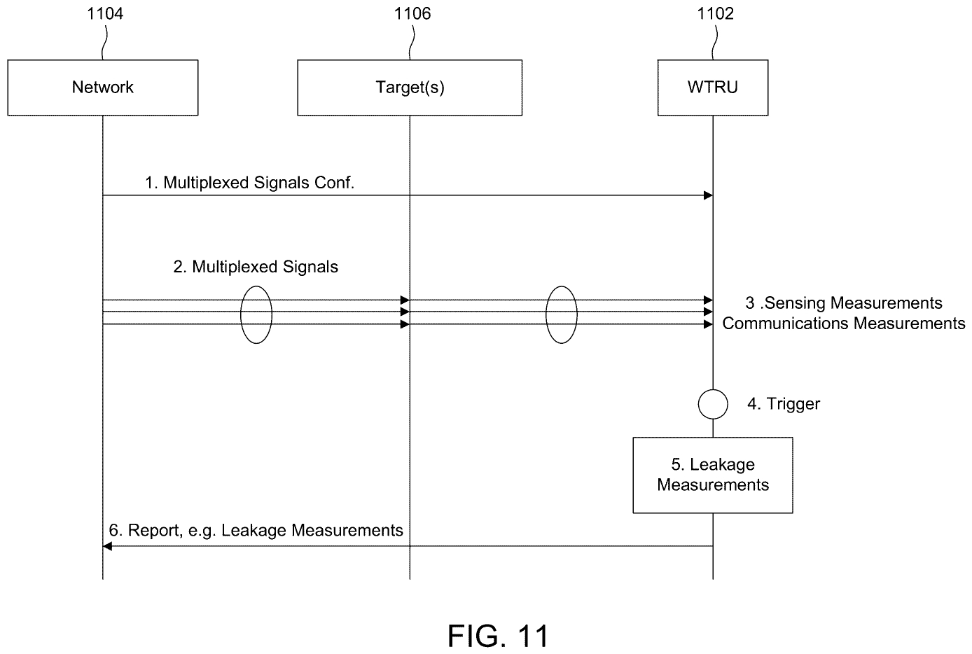

FIG. 11 illustrates a diagram of a multiplexed signal configuration, leakage measurement and reporting procedure according to one or more embodiments. At step 1, a WTRU 1102 may receive multiplexed signals configuration from a network 1104. At step 2, the WTRU 1102 may receive multiplexed signals from the network 1104. At step 3, the WTRU 1102 may perform sensing measurements and communications measurements. At step 4, the WTRU 1102 may detect trigger and at step 5, the WTRU 1102 may perform leakage measurements. At step 6, the WTRU 1102 may transmit to the network 1104 a report that may include the leakage measurements.

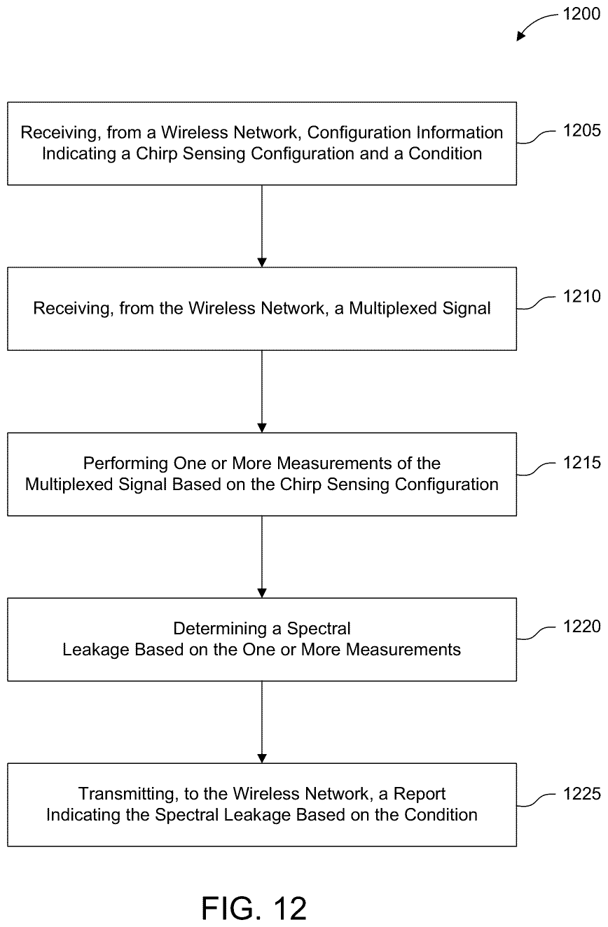

FIG. 12 illustrates a method 1200 for sensing based on a multiplexed signal according to one or more embodiments. The method 1100 may be performed by a WTRU such as any of the WTRUs 102 of FIGS. 1A-1D, the WTRUs 202-203 of FIG. 2, the WTRUs 901-903 of FIG. 9, the WTRU 1102 of FIG. 11. The method 1200 may include receiving 1205, from a wireless network, configuration information indicating a chirp sensing configuration and a condition. In some embodiments, the receiving 1205 may correspond to step 1 of FIG. 11. The method 1200 may further include receiving 1210, from the wireless network, a multiplexed signal. In some embodiments, the receiving 1210 may correspond to step 2 of FIG. 11. The method 1200 may further include performing 1215, one or more measurements of the multiplexed signal based on the chirp sensing configuration. In some embodiments, the performing 1215 may correspond to step 5 of FIG. 11. The method 1200 may further include determining 1220, a spectral leakage based on the one or more measurements. The method 1200 may further include transmitting 1225, to the wireless network, a report indicating the spectral leakage based on the condition. In some embodiments, the transmitting 1225 may correspond to step 6 of FIG. 11.

In some embodiments, the chirp sensing configuration may comprise information associated with at least one of orthogonal frequency division modulation (OFDM)-chirp leakage, chirp residual measurements, OFDM sub-carrier orthogonality, or chirp power measurements.

In some embodiments, the condition may comprise at least one of an OFDM-chirp leakage threshold, a chirp residual threshold, or an accuracy threshold.

In some embodiments, the configuration information may further indicate a priority function; and the method 1200 may further comprise performing sensing, or sensing and communication, based on the priority function.

In some embodiments, the report may further indicate a recommended priority function.

In some embodiments, the one or more measurements may comprise at least one of an OFDM-chirp leakage measurement, residual measurement, chirp frequency measurement, chirp time measurement, or power measurement.

In some embodiments, the multiplexed signal may comprise a chirp signal and a physical channel signal and the chirp signal and the physical channel signal may be transmitted on different resource blocks (RB).

In some embodiments, the multiplexed signal may comprise a chirp signal and a physical channel signal; and determining the spectral leakage may comprise determining a spectral leakage between the chirp signal and the physical channel signal.

In some embodiments, the report further may indicate at least one of leakage related measurements or chirp residual measurements.

In some embodiments, the report further may indicate recommended configuration information for a chirp signal and/or an OFDM signal.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 6 or means-plus-function claim format, and any claim without the terms “means for” is not so intended.

What is claimed is:

1. A method performed by a wireless transmit/receive unit (WTRU), the method comprising:
receiving, from a wireless network, configuration information indicating a chirp sensing configuration and a condition;
receiving, from the wireless network, a multiplexed signal;
performing one or more measurements of the multiplexed signal based on the chirp sensing configuration;
determining a spectral leakage based on the one or more measurements; and
transmitting, to the wireless network, a report indicating the spectral leakage based on the condition.

2. The method of claim 1, wherein the chirp sensing configuration comprises information associated with at least one of orthogonal frequency division modulation (OFDM)-chirp leakage, chirp residual measurements, OFDM sub-carrier orthogonality, or chirp power measurements.

3. The method of claim 1, wherein the condition comprises at least one of an OFDM-chirp leakage threshold, a chirp residual threshold, or an accuracy threshold.

4. The method of claim 1, wherein:
the configuration information further indicates a priority function; and
the method further comprises performing sensing, or sensing and communication, based on the priority function.

5. The method of claim 1, wherein the report further indicates a recommended priority function.

6. The method of claim 1, wherein the one or more measurements comprises at least one of an OFDM-chirp leakage measurement, residual measurement, chirp frequency measurement, chirp time measurement, or power measurement.

7. The method of claim 1, wherein:
the multiplexed signal comprises a chirp signal and a physical channel signal; and
the chirp signal and the physical channel signal are transmitted on different resource blocks (RB).

8. The method of claim 1, wherein:
the multiplexed signal comprises a chirp signal and a physical channel signal; and
determining the spectral leakage comprises determining a spectral leakage between the chirp signal and the physical channel signal.

9. The method of claim 1, wherein the report further indicates at least one of leakage related measurements or chirp residual measurements.

10. The method of claim 1, wherein the report further indicates recommended configuration information for a chirp signal and/or an OFDM signal.

11. A wireless transmit/receive unit (WTRU) comprising:
a processer; and
a transceiver, wherein the WTRU is configured to:
receive, from a wireless network, configuration information indicating a chirp sensing configuration and a condition;
receive, from the wireless network, a multiplexed signal;
perform one or more measurements of the multiplexed signal based on the chirp sensing configuration;
determine a spectral leakage based on the one or more measurements; and
transmit, to the wireless network, a report indicating the spectral leakage based on the condition.

12. The WTRU of claim 11, wherein the chirp sensing configuration comprises information associated with at least one of orthogonal frequency division modulation (OFDM)-chirp leakage, chirp residual measurements, OFDM sub-carrier orthogonality, or chirp power measurements.

13. The WTRU of claim 11, wherein the condition comprises at least one of an OFDM-chirp leakage threshold, a chirp residual threshold, or an accuracy threshold.

14. The WTRU of claim 11, wherein:
the configuration information further indicates a priority function; and
the WTRU is further configured to perform sensing, or sensing and communication, based on the priority function.

15. The WTRU of claim 11, wherein the report further indicates a recommended priority function.

16. The WTRU of claim 11, wherein the one or more measurements comprises at least one of an OFDM-chirp leakage measurement, residual measurement, chirp frequency measurement, chirp time measurement, or power measurement.

17. The WTRU of claim 15, wherein the multiplexed signal comprises a chirp signal and a physical channel signal; and
the chirp signal and the physical channel signal are transmitted on different resource blocks (RB).

18. The WTRU of claim 11, wherein:
the multiplexed signal comprises a chirp signal and a physical channel signal; and
the WTRU configured to determine the spectral leakage comprises determining a spectral leakage between the chirp signal and the physical channel signal.

19. The WTRU of claim 11, wherein the report further indicates at least one of leakage related measurements or chirp residual measurements.

20. The WTRU of claim 11, wherein the report further indicates recommended configuration information for a chirp signal and/or an OFDM signal.
